(19) United States
(12) Patent Application Publication
(10) Pub. No.: US 2020/0057002 A1
(43) Pub. Date: Feb. 20, 2020

(54) APPARATUS AND METHOD FOR NON-DESTRUCTIVE IN SITU TESTING OF WINDMILL BLADES USING PENETRATING DYE

(71) Applicant: PRO DRONES USA, LLC, Rome, NY (US)

(72) Inventor: Jeremy Jung, Pincourt (CA)

(73) Assignee: PRO DRONES USA, LLC, Rome, NY (US)

(21) Appl. No.: 16/606,839

(22) PCT Filed: May 12, 2017
(86) PCT No.: PCT/US2017/032561

§ 371 Date: Oct. 28, 2019

(51) Int. Cl. G01N 21/91; F03D 17/00; B64C 39/02; B64D 47/08; B64D 47/02; B64D 1/18; B08B 3/02

(52) U.S. Cl. CPC G01N 21/91; F03D 17/00; B64C 39/024; B64D 47/08; B64D 47/02; B64C 2201/126; B08B 3/024; B64C 2201/146; B64C 2201/127; B64C 2201/027; B64D 2203/00; B64D 1/18

(57) ABSTRACT

A method and apparatus for undertaking remote non-destructive in-situ testing an elevated wind turbine blade includes the steps of providing a remotely controlled drone aircraft, applying a water soluble penetrant from the drone aircraft to a test surface area of the turbine blade, and then waiting for the water soluble penetrant to dry. Next, a dry powder developer is applied from the drone aircraft to the test surface area, and then awaiting for the dry powder developer to substantially set. The test surface area is then illuminated with an ultraviolet light source from the drone aircraft. Lastly, the test surface area is digitally photographed to effect an inspection for visible latent defects. Additionally, a solvent can be applied from the drone aircraft to rinse the test surface area of the wind turbine blade after waiting for the water soluble penetrant to dry and prior to applying the dry powder developer.

### TECHNICAL FIELD

The present invention is related to method and apparatus for non-destructive in situ inspection of wind turbine blades and power generating equipment in rotating wind turbine generators.

### BACKGROUND OF THE INVENTION

Due to their large size, inspection extensive surface area and complex shape, wind turbine blades are difficult to non-destructively inspect in the factory. Visual inspection alone does not detect latent defects, especially those below the blade's surface. Thermography inspection techniques are somewhat effective but can produce false positives and false negatives due to variations in material thickness and surface emissivity. Angle beam ultrasonic techniques are very slow and may not adequately penetrate thick carbon fiber spar caps. As a result, blades are typically installed on towers and placed into service with a significant probability of undetected latent manufacturing defects. Furthermore, composite blades are subject to seasonal temperature variations and entrapped water can undergo freeze/thaw cycles causing internal damage. Cyclic forces of gravity and varying operational forces acting on the blades as they rotate can cause fatigue damage or the propagation of latent defects over time.

Detecting progressive damage and propagating defects in wind turbine blades in situ is difficult. Inspections employing sky cranes or rope access are expensive, time consuming and can expose personnel to an extremely hazardous work environment. While up-tower, close access allows inspectors to visually detect certain blade features such as trailing edge splits, cracks, lightening damage and blade erosion, such inspections are intermittent expensive and subjective.

The blades of commercial wind turbines are often several hundred feet off the ground. Access to wind turbine blades in situ with portable instruments for non-destructive testing accordingly has conventionally required rope access or sky platforms and cranes. This is time-consuming and potentially dangerous if appropriate safeguards are not followed or if there is an equipment failure. Blade and tower crawlers with non-destructive testing sensors for in situ inspection are known, however again with high cost implications, slow inspection rates and questionable effectiveness. Microwave and radar scanners, while effective for dielectric materials, do not work effectively on critical areas such as spar caps, which are often manufactured with electrically conductive carbon fiber materials.

New utility scale wind turbine blade designs are typically fatigue tested to failure at special facilities to accommodate the large scale, often 50 meters span or more. Frequently, sensors such as Bragg strain gages and acoustic emission (AE) sensors are bonded to the structures to allow monitoring during the entire test cycle. While the use of acoustic emission (AE) sensors and technology is highly effective for detecting and locating propagating defects during ground based fatigue testing, standard AE practice requires bonding sensors to the blade throughout its span and in critical areas. The range of Rayleigh waves propagating in fiberglass is limited and multiple sensors are required raising cost and power requirements. Retrofitting a fleet of blades on wind generators in situ is expensive and hazardous.

Electricity generators designed to extract energy from the wind are powered by rotating turbines as either vertical axis wind turbines (VAWT) or horizontal axis wind turbines (HAWT). Large industrial scale power turbines are generally of the HAWT design using composite air foil shaped blades to generate the rotational torque needed to drive an associated electrical generator. Current utility scale wind turbine blades may range from 9 meters in length up to more than 50 meters, with much larger blades being designed for offshore wind power generators. The application of the present invention may achieve good results on blades of all lengths and locations.

A need accordingly exists for cost effective wind turbine blade health monitoring system, both for the aging existing fleet as well as new wind turbines. There is a particular need for a wind turbine blade non-destructive testing system that is capable of performing testing and monitoring remotely employing ground based personnel, and that is capable of providing remote notification or alerts as to the existence of propagating defects.

A search of issued U.S. patents in the field of monitoring wind turbine blades for defects in situ reveals U.S. patents related generally to the field of the present invention but which do not anticipate nor disclose the apparatus or method of the present invention. The discovered U.S. patents relating generally to the present invention are discussed herein below.

U.S. Pat. No. 9,194,843 B2 to Newman entitled “Method and Apparatus for Monitoring Wind Turbine Blades During Operation” discloses a wind power blade inspection system positioned on the blade root end bulkhead to receive airborne acoustic signals emanating from anomalies in rotating turbine blades during cyclic stress loading, a three axis accelerometer to determine the gravity vector and other sources of cyclic acceleration with respect to the acoustic signals and a signal analysis system configured to analyze the sensor and accelerometer signals to provide data for wind power asset management.

U.S. Application Publication No. 2014/0278151 A1 to Newman entitled “Non-Destructive Acoustic Doppler Testing of Wind Turbine Blades from the Ground During Operation” discloses a wind turbine blade inspection system including a sensitive microphone positioned near the base of the turbine tower to receive acoustic signals emanating from anomalies in rotating turbine blades and a signal analysis system configured to analyze the acoustic signals including a Doppler analysis. The data may be centrally monitored for wind power asset management/

U.S. Application Publication No. 2012/0136630 A1 to Murphy et al. entitled “Method and System for Wind Turbine Inspection” discloses a method and system for inspecting a wind turbine including at least one remotely operated aerial platform (ROAP), providing at least one non-destructive evaluation (NDE) device attached to the ROAP, and providing at least one distance measuring system attached to the ROAP. The distance measuring system is used for determining the distance between the ROAP and at least a portion of the wind turbine. The method also includes positioning the ROAP so that the at least one non-destructive evaluation device captures data used for inspecting the wind turbine.

U.S. Application Publication No. 2012/0300059 A1 to Stege entitled “Method to Inspect Components of a Wind Turbine” discloses an unmanned aerial vehicle (UAV) which is guided to the component for inspection. A certain predetermined distance between the UAV and the component is chosen in a way that high resolution images of the component are gathered by the UAV. The images are gathered by an image acquisition system. The inspection is done remote controlled and based upon the images, which are gathered by the UAV.

None of the above listed U.S. patents and published applications disclose or suggest the non-destructive in situ inspection of wind turbine blades and power generating equipment in rotating wind turbine generators as described in the present invention. Each of the above listed U.S. patents and applications (i.e., US 2012/0136630 A1; US 2012/0300059 A1; US 2014/0278151 A1 and U.S. Pat. No. 9,194,843 B2) are hereby incorporated herein by reference.

### SUMMARY OF THE INVENTION

The forgoing problems and limitations are overcome and other advantages are provided by a new and improved reconfigurable apparatus and method for non-destructive in situ testing of windmill blades using penetrating dye which provides flexibility and user convenience for detecting latent defects and operator remote control and programmability.

Therefore, it is an object of the present invention to provide a novel reconfigurable windmill blade testing system.

The present invention provides a method of non-destructive in-situ testing an elevated wind turbine blade comprising the steps of providing at least one remotely controlled drone aircraft, applying a water soluble penetrant from the remotely controlled drone aircraft to a test surface area of the wind turbine blade, waiting for water soluble penetrant to substantially dry. Thereafter, a dry powder developer is applied from the remotely controlled drone aircraft to the test surface area. After waiting for the dry powder developer to substantially set, the test surface area is illuminated with an ultraviolet light source from the remotely controlled drone aircraft. Lastly, the test surface area from the remotely controlled drone aircraft is digitally photographed to effect an inspection for visible latent defects.

According to another aspect of the invention, an apparatus for non-destructive in-situ testing of an elevated wind turbine blade comprises a remotely controlled drone aircraft, a multi-axis gimbaled mounting frame carried by the remotely controlled drone aircraft supporting at least one operating package, and a ground based controller operable to actuate flight controls of the drone aircraft and functionality of the one or more operating packages.

According to yet another aspect of the invention, the drone aircraft includes an inertial guidance system operable to maintain said operating package in a fixed orientation vis-à-vis with a test surface area of said wind turbine blade.

According to yet another aspect of the invention, a dynamic nozzle is provided which is operable to selectively vary the configuration and/or position of the shaped distribution of the dry powder developer (i.e., position and focus the spray distribution) within the test surface area of the wind turbine blade.

These and other features and advantages of this invention will become apparent upon reading the following specification, which, along with the drawings, describes preferred and alternative embodiments of the invention in detail.

### BRIEF DESCRIPTION OF THE DRAWINGS

The present invention will now be described, by way of example, with reference to the accompanying drawings, in which:

FIG. 1, is a perspective view of a quadrotor type drone aircraft operated remotely by a ground based operator for in-situ inspection and/or testing of the air foil blades of an elevated or tower mounted wind turbine generator;

FIG. 2, is a perspective view of the quadrotor type drone aircraft of FIG. 1 carrying an easily reconfigurable gimbal mounted instrument package including a camera and an ultraviolet (UV) light illustrated on an enlarged scale;

FIG. 3, is a perspective view of the quadrotor type drone aircraft of FIG. 1 with the aircraft in hovering alignment with and focusing upon a segment of one of the air foil blades;

FIG. 4, is a cross-sectional view of the quadrotor type drone aircraft of FIG. 1 equipped with a zoom camera/distance sensor based instrument package with the aircraft in hovering normal alignment with and focusing upon a segment of one of the air foil blades;

FIG. 5, is a cross-sectional view of the quadrotor type drone aircraft of FIG. 1 equipped with a liquid penetrant spray instrument package with the aircraft in hovering normal alignment with and focusing upon a segment of one of the air foil blades;

FIG. 6, is a cross-sectional view of the quadrotor type drone aircraft of FIG. 1 equipped with a developer spray instrument package with the aircraft in hovering normal alignment with and focusing upon a segment of one of the air foil blades;

FIG. 7, is a cross-sectional view of the quadrotor type drone aircraft of FIG. 1 equipped with an inspection instrument package with the aircraft in hovering normal alignment with and focusing upon a segment of one of the air foil blades, the package including a zoom camera and a ultraviolet (UV) illumination device;

FIG. 8, is a cross sectional view of an alternative liquid penetrant spray instrument package with a flat fan spray dynamic nozzle;

FIG. 9, is a cross-sectional view of on an enlarged scale of the flat fan spray dynamic nozzle of FIG. 8;

FIG. 10, is an overhead view of the effect of the flat fan spray dynamic nozzle of FIG. 8 on a target segment of one of the air foil blades illustrating a dynamic focusing function; and

FIG. 11, is a logic diagram of the sequential process steps for operating the various instrument packages in inspection of air foil blades of a wind turbine generator.

Although the drawings represent embodiments of the present invention, the drawings are not necessarily to scale and certain features may be exaggerated in order to illustrate and explain the present invention. The exemplification set forth herein illustrates an embodiment of the invention, in one form, and such exemplifications are not to be construed as limiting the scope of the invention in any manner.

### DESCRIPTION OF THE PREFERRED EMBODIMENTS

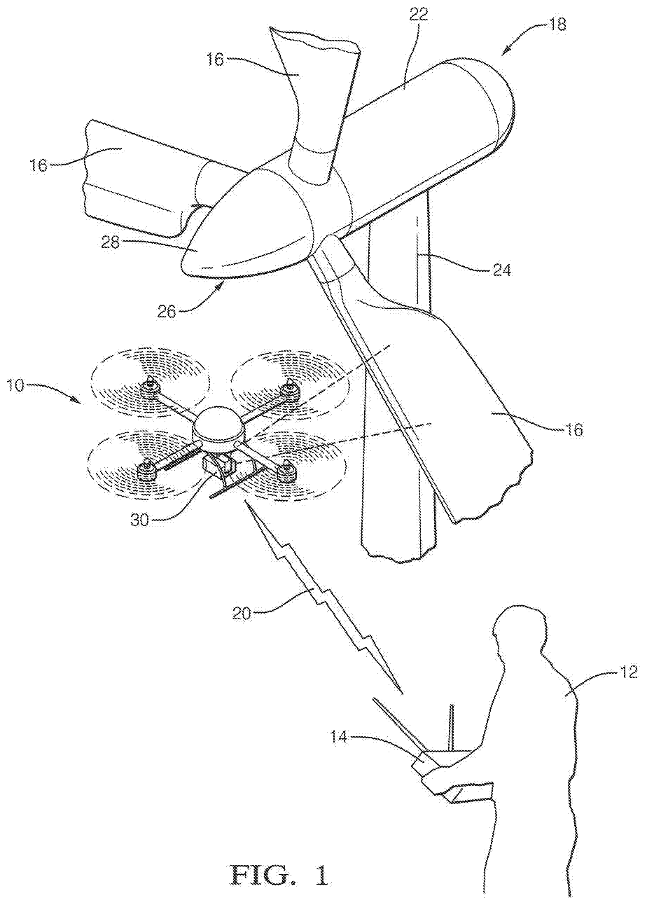

Referring to the drawing figures, and particularly to FIG. 1, a preferred embodiment of a reconfigurable windmill inspection apparatus and method in accordance with the present invention is illustrated. A quadrotor type drone aircraft 10 such as those produced by Microdrones GmbH can be operated remotely by a ground based operator 12 manipulating a base station 14 for in-situ inspection of the air foil or rotor blades 16 carried by a rotating hub 28 of a wind turbine generator 18. The base station 14 is interconnected with the drone aircraft 10 by a multi-channel radio frequency (RF) link 20. Flight control and operating instructions for the drone aircraft 10 are either stored in controller memory of the base station 14 or a controller (not illustrated) within the drone aircraft 10. The drone aircraft 10 carries an easily reconfigurable gimbal mounted instrument or operating package 30.

Although varied configurations of drone aircraft 10 such as depicted herein can be employed in modified form to practice the present invention, the applicant believes that drones produced by Microdrones Gmbh of the md4—Series equipped with the mdOS v 4.3 firmware provide acceptable performance. The Operator's Handbook Revision 2016-04-21—R3.00, CPK, SS, MP, MMP © 2007-2016 provided by Microdrones Gmbh is incorporated herein by reference in its entirety to serve as supplemental descriptive material for this application. Reference: www.microdrones.com.

The wind turbine 18 typically includes a nacelle 22 housing an electrical generator (not illustrated). The nacelle 22 is mounted atop a tall tower 24. The wind turbine generator 18 also comprises a rotor 26 that includes one or more (typically three) elongated rotor blades 16 which are each rotatable about their respective axes of elongation to vary the effective pitch of the blades 16.

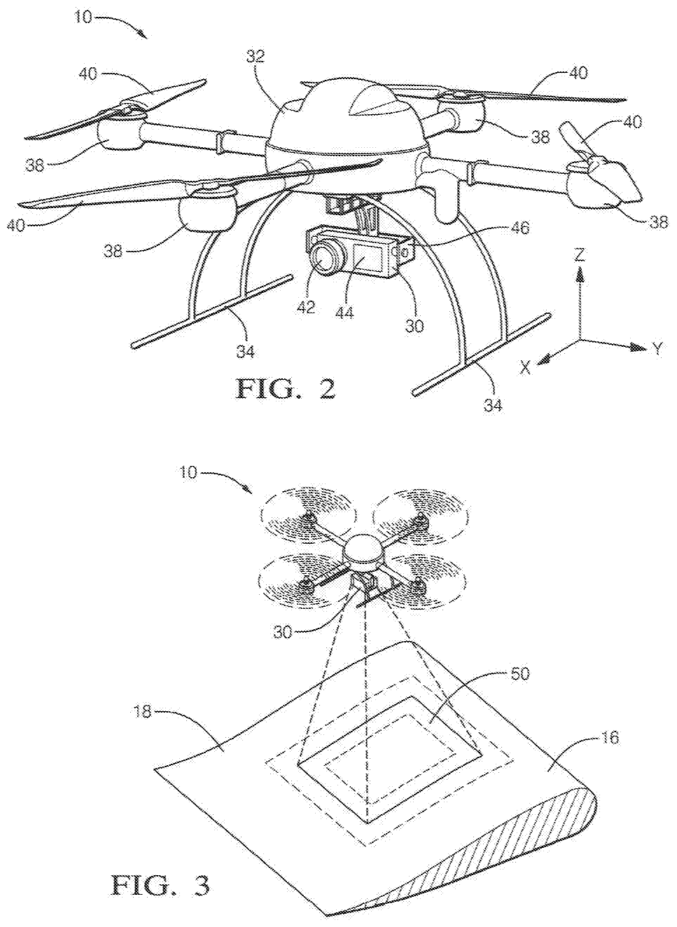

As best seen in FIG. 2, the quadrotor type drone aircraft 10 consists of a center pod 32 containing a battery, motor and control electronics. Resilient landing struts 34, as well as the gimbal mounted instrument or operating package 30 extend below the lower surface 36 of the center pod 32. The gimbal mount 46 is illustrated in an extremely simplified, schematic form, it being understood that it enables at least three degrees of rotational freedom (i.e., yaw, pitch and roll) of the operating package 30 with respect to the center pod 32 of the drone aircraft 10. Furthermore, it can enable independent bidirectional translation along three (e.g., X, Y and Z) axes of the operating package 30 with respect to the center pod 32 of the drone aircraft 10. Four circumferentially arranged arms with motor pods 38 extend outwardly from the center pod 32, each supporting a rotor 40. The illustrated gimbal mourned instrument or operating package 30 includes a digital camera 42 and a UV light 44.

Preferably, the UV light comprises a LCNDT UV 100C Certified LED UV lamp. The digital camera 42 is preferably a Sony HX90V with 30× optical zoom and 18.1 MP features.

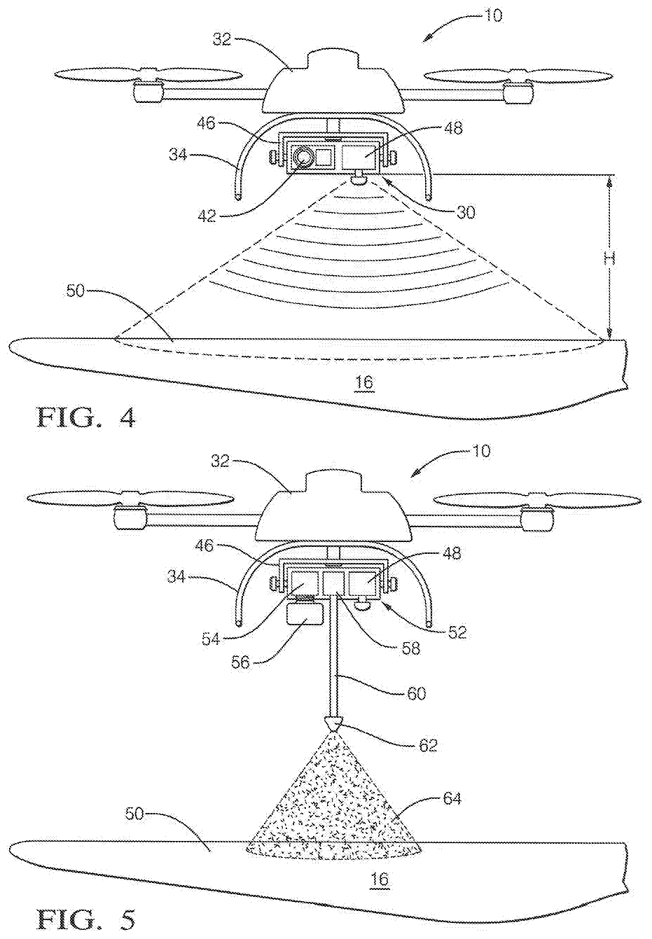

Referring to FIGS. 3 and 4, the quadrotor type drone aircraft 10 of FIG. 1 is illustrated hovering above an air foil blade 16 at a distance H enabling the camera 42 and range finder 48 to define a target or test surface area 50 on an exposed (particularly upper) surface of the air foil blade 16. The range finder 48 can be incorporated within the camera 42. Once the test surface area 50 is established, the drone aircraft 10 is maintained in a fixed relationship with the test surface area 50 throughout each step of the testing process.

Referring to FIG. 5, once the test surface area is defined in the flight controller, the drone aircraft 10 returns to the ground based operator 12 who removes the instrument package 30 illustrated in FIGS. 1-4 and replaces it with a penetrant spray package 52 containing a fluid metering network 54, a removable penetrant spray reservoir 56, a pump 58, an elongated wand 60 and a dynamic spray nozzle 62. In operation, the pump 58 draws liquid penetrant from the reservoir 56 through the fluid metering network 54 and ejects it under pressure through the wand 60 and nozzle 62 to establish a spray pattern 64 directed against the test surface area 50 of the target air foil blade 16. This process step continues until the entire test surface area is coated with the penetrant.

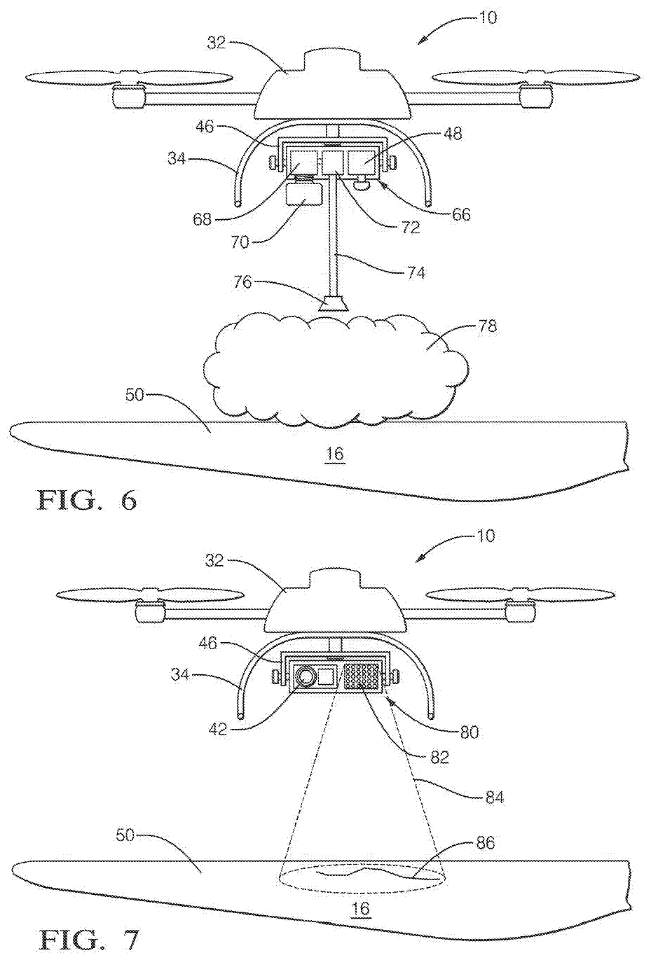

Referring to FIG. 6, once the test surface area 50 is coated by the penetrant and the penetrant has satisfactorily dried, the drone aircraft 10 returns to the ground base operator 12 who removes the penetrant spray package 52 illustrated in FIG. 5 and replaces it with a dry developer spray package 66 containing a fluid metering network 68, a removable developer spray reservoir 70, a pump 72, an elongated wand 74 and a dynamic spray nozzle 76. In operation, the pump 72 draws fluid penetrant from the reservoir 70 through the fluid metering network 68 and ejects it under pressure through the wand 74 and nozzle 76 to establish a spray pattern 78 directed against the test surface area 50 of the target air foil blade 16. This process step continues until the entire test surface area is coated with the developer.

The wands 60 and 72 are dimensioned as a function of the viscosity of the fluid being disbursed and the amount of rotor down wash and vortices. The length of the wands is selected to minimize disruption of the spray patterns 64 and 78 during operation.

Referring to FIG. 7, once the test surface area 50 is coated by the developer and the developer has satisfactorily reacted with the penetrant, the drone aircraft 10 returns to the ground base operator 12 who removes the developer spray package 66 illustrated in FIG. 6 and replaces it with a documentation package 80 containing a focused UV light source 82 and a digital camera 42 including a range finder. The UV light source 82 focuses a beam 84 on the test surface area 50 to highlight and document visible or latent defects in the air foil blade 16 under test.

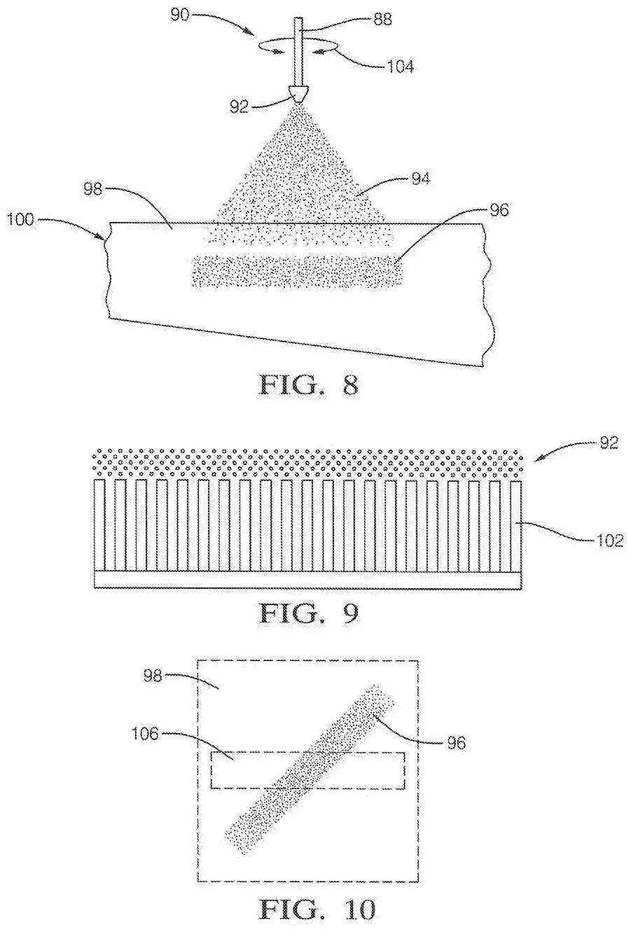

Referring to FIGS. 8-10, an alternative spray wand 88, preferably for use with a modified form dry developer spray package 90 includes a flat fan spray dynamic nozzle 92 which produces a spray pattern 94 which adheres in a rectangular shape 96 on a test surface area 98 of an air foil blade 100. The nozzle 92 has a directional manifold 102 which forms the rectangular shape. The nozzle 92 can be rotated, as indicated by arrow 104 to rotate the rectangular shape 92 to an altered orientation 106 as illustrated in phantom.

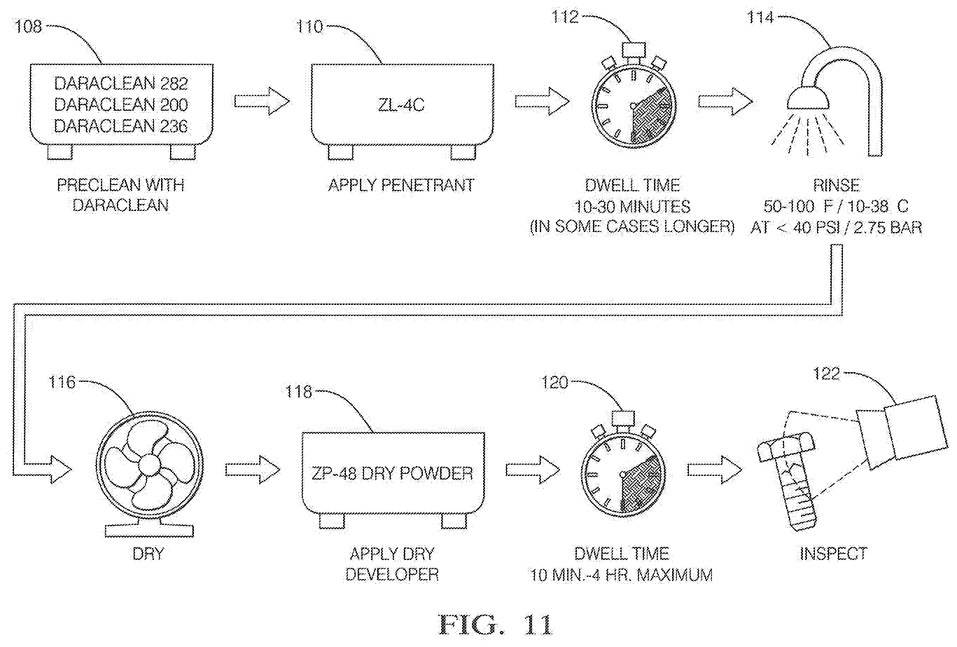

Referring to FIG. 11, a sample water wash fluorescent test method is illustrated that is deemed useful with tower mounted commercial windmills, particularly those with aluminum or carbon composite fiber air foil blade structures. As a first step 108, a test surface area is pre-cleaned employing (for example) Daraclean 282, 200 or 236 employing a spray package similar to previously described penetrant spray package 52 in FIG. 5.

As a second step 110, the test surface area is applied with penetrant (for example) ZL-4C employing a spray package similar to previously described penetrant spray package 52 in FIG. 5.

Although various water soluble penetrants can be used in practicing the present invention, ZYGLO® ZL-4C Water Soluble Penetrant produced by Magnafiux can be applied. ZYGLO® ZL-4C is a biodegradable, fluorescent, water base penetrant that is soluble in water and can be diluted infinitely, but is generally used as supplied or diluted from 1:1 to 1:2 in water. It contains no petroleum base solvents and fluoresces a greenish-yellow color under ultraviolet radiation. Use of a black light source with a peak wavelength of 365 nm, such as the Magnaflux® ZB-100F Fan Cooled Black Light, is recommended. ZYGLO® ZL-4C is generally used where petroleum solvents may attack a test surface such as on plastics. It may also be used on ceramics and as a leaker penetrant to detect leaks. ZYGLO® ZL-4C is composed of water, fluorescent dye and liquid emulsifying agents, but does not contain a corrosion inhibitor. ZYGLO® ZL-4C has typical properties including no flash point, a density of 7.5 lbs/gal (900 g/l), viscosity (100° F. of 13.5 cs, a pH (@1:1 in water) of 7.0, sulfur content of approximately 1%, <1000 ppm chlorine, and 385 g/l VOC. ZYGLO® ZL-4C produces bright yellow green indications with ZYGLO® penetrants. ZYGLO® ZL-4C can include nonylphenol ethoxylate (@10-30 by weight), diethylene glycol (@ 10-30 by weight) and hexylene glycol (@1-5 by weight). A ZYGLO® ZL-4C Product Data Sheet revised July 2014 is incorporated herein by reference. Furthermore, a ZYGLO® ZL-4C Safety Data Sheet dated 18 Mar. 2016 is incorporated herein by reference.

As a third step 112, the penetrant of step 110 is allowed a 10-30 minute (perhaps longer) drying or dwell time.

As a fourth step 114, the test surface area is rinsed employing a spray package similar to previously described penetrant spray package 52 in FIG. 5 with water @ 50-100° F./10-38° C. at <40 psi/2.75 bar.

As a fifth step 116, the test surface area is allowed to dry.

As a sixth step 118, the test surface area is applied with a dry powder developer (ex.: ZP—4B).

Although various powder developers can be used in practicing the present invention, ZYGLO® ZP-4B Dry Powder Developer produced by Magnaflux can be applied. ZYGLO® ZP-4B is a dry powder developer composed of inert organic materials having typical properties including off-white non-fluorescent color, sub-micron to 30 microns particle size, <1000 ppm sulfur, <1000 ppm chlorine, <500 ppm sodium and NPE free. ZYGLO® ZP-4B can include mixtures of pentaerythritol (@30-60% by weight), magnesium carbonate (@10-30% by weight), aluminum oxide (@1-5% by weight) and silica, amorphous, fumed, crystalline-free (@1-5% by weight). A ZYGLO® ZL-4C Product Data Sheet revised July 2014 is incorporated herein by reference. Furthermore, a ZYGLO® ZL-4C Safety Data Sheet dated 18 Mar. 2016 is incorporated herein by reference.

As a seventh step 120, the developer of step 118 is allowed a 10 minute-4 hour maximum reaction or dwell time.

As a (final) eighth step 122, the test area is scanned using the documentation package 80 of FIG. 7 to highlight and document visible or latent defects in the air foil blade 16 under test.

The following documents are deemed to provide a fuller background disclosure of the inventions described herein and the manner of making and using same. Accordingly, each the below-listed documents are hereby incorporated into the specification hereof by reference.

U.S. Pat. No. 3,564,249 to Molina entitled “Reverse Penetrant Method and Means”.

U.S. Pat. No. 3,803,051 to Molina entitled “Developer Composition for Penetrant Inspection”.

U.S. Pat. No. 3,915,886 to Molina entitled “Water Washable Dye Penetrant Composition and Method for Utilizing Same”.

U.S. Pat. No. 4,191,048 to Molina entitled “Red-Visible Dye Penetrant Composition and Method Employing Same”.

U.S. Patent Application No. 2006/0037402 A1 to Musial et al. entitled “Resonance Rest System”.

U.S. Pat. No. 6,556,298 B1 to Pailiotet entitled “Method and System for Non-Destructive Dye Penetration Testing of a Surface”.

U.S. Pat. No. 8,044,670 B2 to Bjerge et al. entitled “Apparatus and Method for Determining a Resonant Frequency of a Wind Turbine Tower”.

U.S. Patent Application No. 2012/0136630 A1 to Murphy et al. entitled “Method and System for Wind Turbine Inspection”

U.S. Patent Application No. 2012/0300059 A1 to Stege entitled “Method to Inspect Components of a Wind Turbine”.

U.S. Pat. No. 8,631,704 B2 to Guy entitled “Fatigue Testing Device for Wind Turbine Testing, A Method of Testing Wind Turbine Blades and a Control System for a Blade Testing Actuator”.

U.S. Patent Application No. 2014/0278151 A1 to Newman entitled “Nondestructive Acoustic Doppler Testing of Wind Turbine Blades from the Ground During Operation”.

U.S. Pat. No. 9,194,843 B2 to Newman entitled “Method and Apparatus for Monitoring Wind Turbine Blades During Operation”.

It is to be understood that the invention has been described with reference to specific embodiments and variations to provide the features and advantages previously described and that the embodiments are susceptible of modification as will be apparent to those skilled in the art.

Furthermore, it is contemplated that many alternative, common inexpensive materials can be employed to construct the basis constituent components. Accordingly, the forgoing is not to be construed in a limiting sense.

The invention has been described in an illustrative manner, and it is to be understood that the terminology, which has been used is intended to be in the nature of words of description rather than of limitation.

Obviously, many modifications and variations of the present invention are possible in light of the above teachings. For example, various types of drone aircraft can be employed. It is, therefore, to be understood that within the scope of the appended claims, wherein reference numerals are merely for illustrative purposes and convenience and are not in any way limiting, the invention, which is defined by the following claims as interpreted according to the principles of patent law, including the Doctrine of Equivalents, may be practiced otherwise than is specifically described.

1. A method of non-destructive in-situ testing of an elevated wind turbine blade comprising the steps of;
providing at least one remotely controlled drone aircraft;
applying a water soluble penetrant from said remotely controlled drone aircraft to a test surface area of said wind turbine blade;
waiting for said water soluble penetrant to substantially dry;
applying a dry powder developer from said remotely controlled drone aircraft to said test surface area;
waiting for said dry powder developer to substantially set;
illuminating said test surface area with an ultraviolet light source from said remotely controlled drone aircraft; and
photographing said test surface area from said remotely controlled drone aircraft to effect an inspection for visible latent defects.

2. The method of inspecting the wind turbine blade of claim 1, further comprising the step of;
pre-cleaning said test surface area of said wind turbine blade by applying a liquid cleanser from said remotely controlled drone aircraft solvent prior to applying said water soluble penetrant.

3. The method of inspecting the wind turbine blade of claim 1, further comprising the steps of;
applying a solvent from said remotely controlled drone aircraft to at least partially rinse said test surface area of said wind turbine blade after waiting for said water soluble penetrant to substantially dry and prior to applying said dry powder developer.

4. The method of inspecting the wind turbine blade of claim 1, wherein said water soluble penetrant comprises Magnaflux ZYGLO® ZL-4C Water Soluble Penetrant.

5. The method of inspecting the wind turbine blade of claim 1, wherein said dry powder developer comprises Magnaflux ZYGLO® ZP-4B Dry Powder Developer.

6. The method of inspecting the wind turbine blade of claim 1, further comprising the step of prepositioning the wind turbine blade in a predetermined position prior to undertaking said steps.

7. The method of inspecting the wind turbine blade of claim 6, wherein the step of prepositioning the wind turbine blade in a predetermined position prior to undertaking said steps comprises prepositioning the wind turbine blade in a substantially horizontal position prior to undertaking said steps.

8. The method of inspecting the wind turbine blade of claim 1, further comprising the step of prepositioning and maintaining said remotely controlled drone aircraft at a substantially fixed position and distance from said test surface area throughout said test.

9. The method of inspecting the wind turbine blade of claim 1, further comprising the step of repositioning said remotely controlled drone aircraft with respect to said wind turbine blade to a second test surface area and repeating said steps.

10. The method of inspecting the wind turbine blade of claim 1, further comprising the step of providing at least one elongated wand operative disperse said water soluble penetrant and/or said dry powder developer through a nozzle positioned distal said remotely controlled drone aircraft.

11. An apparatus for non-destructive in-situ testing of an elevated wind turbine blade comprising:
a remotely controlled drone aircraft;
a multi-axis gimboled mounting frame carried by said remotely controlled drone aircraft supporting at least one operating package; and
a ground based controller operable to actuate flight controls of said drone aircraft and functionality of said at least one operating package.

12. The apparatus of claim 11, wherein said operating package comprises a downward looking position sensor operable to focus on a test surface area of said wind turbine blade.

13. The apparatus of claim 11, wherein said operating package comprises a downward looking ultraviolet (UV) light source operable to illuminate a test surface area of said wind turbine blade.

14. The apparatus of claim 11, wherein said operating package comprises a digital camera operable to image a test surface area of said wind turbine blade.

15. The apparatus of claim 11, wherein said operating package comprises a reservoir, pump and an elongated wand operable to apply a water soluble penetrant to a test surface area of said wind turbine blade.

16. The apparatus of claim 11, wherein said operating package comprises a reservoir, pump and an elongated wand operable to apply a liquid pre-cleanser to a test surface area of said wind turbine blade.

17. The apparatus of claim 11, wherein said operating package comprises a reservoir, pump and an elongated wand operable to apply a dry powder developer to a test surface area of said wind turbine blade.

18. The apparatus of claim 17, wherein said elongated wand comprises a dynamic nozzle operable apply a shaped distribution of said dry powder developer to the test surface area of said wind turbine blade.

19. The apparatus of claim 18, wherein said dynamic nozzle is operable to selectively vary the configuration and/or position of said shaped distribution of said dry powder developer to the test surface area of said wind turbine blade.

20. The apparatus of claim 11, wherein said operating package comprises an inertial guidance system operable to maintain said operating package in a fixed orientation vis-à-vis with a test surface area of said wind turbine blade.
